(19) United States
(12) Patent Application Publication
(10) Pub. No.: US 2024/0147883 A1
(43) Pub. Date: May 9, 2024

(54) GAUGE WHEEL WITH TINES AND CIRCUMFERENTIAL LINER

(71) Applicant: SCHAFFERT MANUFACTURING COMPANY, INC., Indianola, NE (US)

(72) Inventor: Paul E. SCHAFFERT, Indianola, NE (US)

(21) Appl. No.: 18/501,666

(22) Filed: Nov. 3, 2023

Related U.S. Application Data
(60) Provisional application No. 63/422,683, filed on Nov. 4, 2022.

(51) Int. Cl. A01B 15/16; A01C 5/06

(52) U.S. Cl. CPC A01B 15/16; A01C 5/064

(57) ABSTRACT

An agricultural gauge wheel includes a hub which rotates about an axis, a rim extending generally radially from the axis, the rim defining a circumferential portion and a center plane defined as a plane perpendicular to the axis and bisecting the rim, and a tread including a plurality of tread portions extending away from the center plane to an outer tread edge. The plurality of tread portions define an inside diameter of the tread and the gauge wheel also includes a liner secured to the rim, the liner including an outer diameter less than or equal to the inside diameter of the tread and extending beyond the outer tread edge.

### CROSS-REFERENCE TO RELATED APPLICATIONS

This application claims the benefit of priority pursuant to 35 U.S.C. 119(e) of U.S. Provisional Patent Application No. 63/422,683, filed Nov. 4, 2022, entitled “Gauge Wheel with Tines and Circumferential Liner,” which is hereby incorporated by reference herein in its entirety.

### FIELD

The described embodiments of the present disclosure relate to trailing arm assemblies of agricultural planters. Specifically, the described embodiments of the present disclosure relate to gauge wheels of trailing arm assemblies.

### BACKGROUND

Agricultural seed planting is typically accomplished by multi-row planters. Each planter may include multiple row units adapted for clearing debris on the field surface, opening a seed furrow, depositing seeds within the furrow, and closing the seed furrow around the seeds. In some cases, each row unit of the planter may also open a fertilizer furrow adjacent to each seed furrow, deposit liquid fertilizer in each fertilizer furrow, and close each fertilizer furrow.

Some planters are equipped or retrofitted to be equipped with fertilizer depositing equipment (e.g., fertilizer furrow opener discs and fertilizer deposit tubes) located on a leading or front side of the planter. Planters so configured may have problems in fields with moist or wet soil. Specifically, disturbing the soil with the fertilizer equipment located in front of the planter gauge wheels may cause the moist or wet soil to accumulate on the gauge wheels. The soil accumulation increases the effective diameters of the gauge wheels and causes the planter to run too shallow with respect to the depositing of the seed in the seed furrows.

Planters are increasingly used in no-till situations, resulting in the planter traversing fields with substantial deviation in the field surface and a substantial amount of obstructions (e.g., debris, clods, stubble, old furrows, etc.). Furthermore, in certain Midwest farm areas, ditches must be plowed in fields between planting seasons to facilitate the drainage of spring showers from the fields. Most planters have proven ineffective in such rough field surface conditions. It is not unusual for the use of planters in rough field conditions to result in seed depths that radically range between too deep and too shallow. Also, it is not unusual for the use of planters in such field conditions to result in the planter components being damaged.

Furrow opener assemblies rely on gauge wheels to roll over and contact a top surface of the soil as an adjacent furrow opener disc digs into the soil to open a furrow. The gauge wheel uses the surface of the field as a reference to set the depth of the adjacent opener disc. Row cleaner assemblies may include wheels configured to sweep away debris on the surface of the field ahead of the furrow opener disc and gauge wheel. Sweeping away debris may prevent the gauge wheel from rolling over the debris and using the debris as a reference for controlling the depth of the furrow. However, typical row cleaner assemblies may nonetheless be negatively affected by moist or wet soil conditions where, for example, the soil or other debris sticks to the gauge wheel and the furrow opener disc. The accumulation of wet soil and debris on the gauge wheel and opener disc may negatively affect the furrow depth, consistency, and geometry, leading to poor planting and growing conditions for seeds placed into the furrows.

Thus, there is a need in the art for a planter capable of removing soil and debris accumulating on the opener disc and the gauge wheel.

### SUMMARY

Examples of the present invention are directed to trailing arm assemblies with compact linkage assemblies.

In one example, an agricultural gauge wheel includes a hub which rotates about an axis, a rim extending generally radially from the axis, the rim defining a circumferential portion and a center plane defined as a plane perpendicular to the axis and bisecting the rim, and a tread including a plurality of tread portions extending away from the center plane to an outer tread edge. The plurality of tread portions define an inside diameter of the tread and the gauge wheel also includes a liner secured to the rim, the liner including an outer diameter less than or equal to the inside diameter of the tread, the liner extending laterally beyond the outer tread edge.

In one example, the tread defines voids between adjacent tread portions.

In one example, the liner defines an outer liner edge disposed further beyond the outer tread edge relative to the center plane.

In one example, the liner includes a cylindrical tube.

In one example, the liner is a first liner and the agricultural gauge wheel includes a second liner.

In one example, the rim is disposed between the first liner and the second liner.

In one example, each of the tread portions are formed from a tine extending from a radial surface of the rim in a direction that includes a component in one or more of a radial direction defined by an outer edge of the rim, a component in an axial direction, or a component in a tangential direction.

In one example, the tine and the radial surface define a tine plane that forms a chord along the radial surface that intersects no more than two chords of adjacent tread portions within the circumferential portion.

In one example, a wheel includes a rim, a plurality of spaced apart tread portions extending from the rim and defining an outer circumferential surface of the wheel, and a cylindrical liner disposed radially inward from the plurality of spaced apart tread portions, the cylindrical liner defining an outermost peripheral edge of the wheel and the outer circumferential surface of the wheel.

In one example, the cylindrical liner is secured to the rim.

In one example, the cylindrical liner is tubular.

In one example, the cylindrical liner is a first cylindrical liner disposed on a first side of the rim and the wheel further includes a second cylindrical liner disposed on a second side of the rim opposite the first side such that the rim is disposed between the first cylindrical liner and the second cylindrical liner.

In one example, the first cylindrical liner is secured to the second cylindrical liner via a bracket extending through the rim.

In one example, the cylindrical liner is removably attached to the wheel.

In one example, a trailing assembly includes a furrow opener wheel and a gauge wheel including a peripheral edge adjacent the furrow opener wheel. In such an example, the peripheral edge of the gauge wheel is configured to scrape debris off of the furrow opener wheel during use.

In one example, the gauge wheel includes a rim rotatable around a first axis of rotation, the rim defining a first plane, the peripheral edge defines a second plane parallel to the first plane, and the second plane is disposed between the furrow opener wheel and the first plane defined by the rim.

In one example, the trailing assembly further includes a plurality of tread portions extending away from the first plane to an outer tread edge.

In one example, a first distance separates the peripheral edge from the first plane, a second distance separates the outer tread edge from the first plane, and the second distance is less than or equal to the first distance.

In one example, the furrow opener wheel defines a second axis of rotation non-parallel to the first axis.

In one example, the furrow opener wheel defines a first rotational center, the gauge wheel defines a second rotational center, and the second rotational center is disposed above the first rotational center relative to a field surface during use.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 depicts an embodiment of an agricultural tractor pulling a planter assembly;

FIG. 2 depicts a rear perspective view thereof;

FIG. 3 depicts a side view of an embodiment of a trailing assembly for an agricultural planter;

FIG. 4A depicts a side view of an embodiment of a gauge wheel and an opener disc of a furrow opener assembly;

FIG. 4B depicts a front view thereof;

FIG. 5A depicts a perspective view of an embodiment of a gauge wheel;

FIG. 5B depicts an exploded view thereof;

FIG. 5C depicts a front view thereof;

FIG. 5D depicts a side view thereof;

FIG. 5E depicts a partial view thereof;

FIG. 6A depicts a perspective view of an embodiment of a gauge wheel;

FIG. 6B shows a partial view thereof;

FIG. 6C shows a front view thereof; and

FIG. 7 shows a front view of an embodiment of a gauge wheel and an opener disc as part of a furrow opener assembly.

### DETAILED DESCRIPTION

The description that follows includes sample systems, methods, and apparatuses that embody various elements of the present disclosure. However, it should be understood that the described disclosure may be practiced in a variety of forms in addition to those described herein.

The described embodiments of the present disclosure relate to trailing arm assemblies of agricultural planters. Specifically, the described embodiments of the present disclosure relate to gauge wheels of trailing arm assemblies. In at least one embodiment, the furrow opener assembly (such as in one example a planter row unit) is disposed behind or “rearward” from a tool bar of an agricultural planter. In at least one embodiment, the furrow closer assembly may be secured behind the furrow opener assembly. For example, a second parallel linkage may secure the furrow closer frame to the furrow opener frame. In this way, the furrow closer assembly and components thereof, including the furrow closer frame and one or more furrow closer discs, may translate vertically relative to the furrow opener assembly as the trailing assembly is moved forward over the field surface.

In at least one embodiment, the furrow opener assembly may include a gauge wheel is configured to roll across a top surface of the field and set a depth of the opener disc extending into the ground. In at least one embodiment, the gauge wheel is configured to press against but not dig into the surface to maintain the opener frame at a consistent height relative to the surface. The opener disc may be rotatably secured to the opener frame such that a depth at which the opener disc penetrates below the surface to form a furrow in the field is also consistent. In this way, in at least one embodiment, the gauge wheel may function to set and maintain the depth of the furrow created by the furrow opener disc.

Embodiments of the gauge wheel shown in the figures and described herein may be configured to maintain consistent furrow depths and geometries in a variety of soil conditions. For example, wet or moist soil may typically tend to stick to and build up on the outer edges and surfaces of the opener disc as the opener disc is moved along to penetrate the field surface. However, the gauge wheels described herein may be configured to remove such build up on the opener disc during operation.

Accordingly, at least one embodiment of a gauge wheel may include a hub which rotates about an axis, a rim extending generally radially from the axis, the rim defining a circumferential portion and a center plane defined as a plane perpendicular to the axis and bisecting the rim, a tread including a plurality of tread portions extending away from the center plane to an outer tread edge. The plurality of tread portions may define an outside diameter of the tread and an inside diameter of the tread. In addition, the gauge wheel may include a liner secured to the rim, the liner including an outer diameter less than or equal to the inside diameter of the tread and extending beyond the outer tread edge.

In such an embodiment, the liner may define an outermost edge of the gauge wheel, which may be disposed against or in close proximity to an edge or surface of an opener disc assembled with the furrow opener assembly of the gauge wheel. In this way, the outermost edge of the liner may be configured to scrape off debris accumulated on the opener disc as the opener disc extends into the soil to form a furrow. Removing debris from the opener disc by the liner, or by the outermost edge of the gauge wheel defined by the liner, may form a clean portion of the opener disc rotating into the soil. This clean portion of the opener disc is free of debris so as to form a consistent furrow at an appropriate depth and geometry to promote successful planting and growing of seeds in the furrow.

In addition, in at least one embodiment, the plurality tread portions include voids or spaces between adjacent tread portions. In this way, with the liner disposed radially inward to the tread portions, the outer surface of the liner and the tread portions combine to form an outermost circumferential surface of the gauge wheel configured to press against and contact the soil during operation. The tread portions form raised portions of such an outer surface to vary the topography of the surface of the gauge wheel contacting the surface of the field. The varied topography discourages wet or moist soil from sticking and accumulating on the gauge wheel. That is, the voids between the tread portions and the varied topography of the surface of the gauge wheel formed by the tread portions tend to form discrete clumps or sections of soil sticking to the surface. These discrete sections are more likely to fall off the surface of the gauge wheel before further layers of soil and debris build up on existing soil stuck to the wheel. In addition, the tread portions provide raised features on the external surface of the wheel to increase traction on the field surface during use.

In such an example, the liners forming the outer circumferential surface of the gauge wheel may prevent soil and debris from clogging between the treads and building up on the rim during use as the gauge wheel is pressed and rolled over the field surface. In this way, the liners may act as a barrier to the ingress of soil and dirt between and through the treads. In addition, the outer circumferential surface of the gauge wheel has an increased surface area, in addition to the outer surface defined by the treads, to prevent the gauge wheel from sinking into soft or wet soil and impacting the depth of the furrow being opened.

Thus, embodiments of gauge wheels described herein reduce or prevent the build-up of soil and debris on the opener disc and the gauge wheel itself. This results in more consistent furrow depths and geometries.

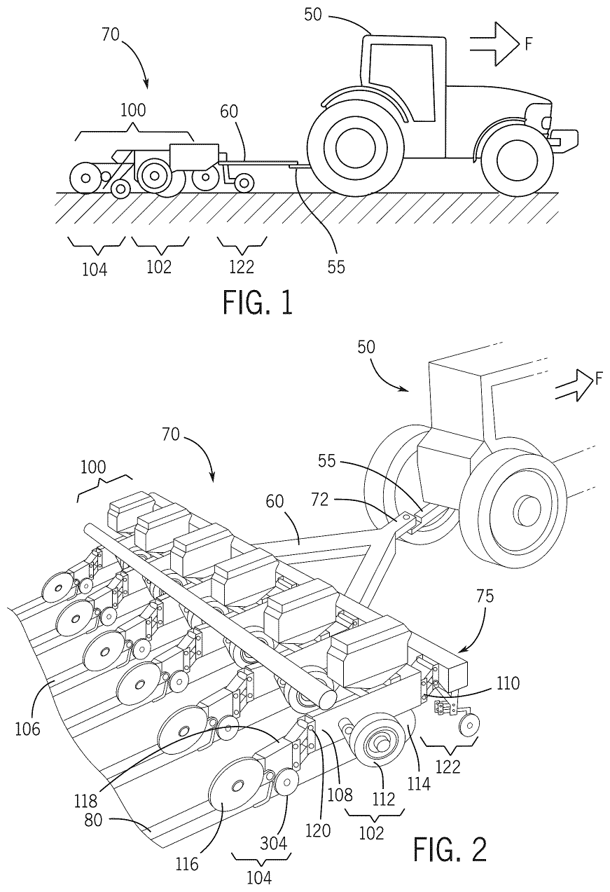

These and other embodiments are discussed below with reference to FIGS. 1-7. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

An exemplary embodiment of an agriculture planter 70 having one or more trailing arm assemblies 100 attached to an agricultural tractor 50 is shown in FIGS. 1 and 2. The linkage assemblies of the present disclosure may be used with the agriculture planter 70 and/or trailing arm assemblies 100, as described herein below. For purposes of illustration, the agricultural tractor 50 may have a hitch receiver 55 extending rearward therefrom. As illustrated in FIG. 2, the planter 70 may include a tool bar 75 from which a yoke or frame 60 with a tongue or hitch 72 extends in a forward direction F. The hitch 72 connects with the hitch receiver 55 to couple the planter 70 to the tractor 50. Various planter components are supported on the tool bar 75 and extend therefrom in a rearward direction (opposite the forward direction F). The tractor 50 tows the planter 70 in the forward direction F indicated by the arrow and provides power to the planter 70 (e.g., via a power take off (“PTO”), not shown) for powering the operations of the planter 70. Additional operations of the planter 70 may be powered by hydraulics or electrical motors (not shown) powered by the tractor 50.

Components of the planter 70 may include a plurality of trailing arm assemblies 100. The trailing arm assemblies 100 may function as row units for planting seeds and distributing liquid fertilizer. Each trailing assembly 100 may be coupled with the tool bar 75 or yoke that extends from the front of the trailing assembly 100. Each trailing assembly 100 may be equipped with a furrow opener assembly 102. Each trailing assembly 100 may also be equipped with a trailing furrow closer assembly 104. As used herein, the term “row unit” may refer to a portion of the trailing assembly 100 configured to open and close a single furrow (e.g., furrow 106). For example, a row unit may include a single furrow opener assembly 102 coupled to and ahead of a single furrow closer assembly 104 to open and close, respectively, the same furrow 106.

In the exemplary embodiment shown, the furrow opener assembly 102 may include an opener assembly frame 108, which may be connected to the tool bar 75 via a parallel linkage 110, such as any of the linkage assemblies or parallel linkages described herein. The parallel linkage 110 allows the furrow opener assembly 102 and the furrow closer assembly 104 to move/translate up and down vertically (generally orthogonal to forward direction F) to follow the terrain (e.g., contours of the field), overcome obstacles (e.g., debris or the like), or otherwise negotiate similar changes in a surface 80 of a field. The furrow opener assembly 102 may include a gauge wheel 112 and an opener disc 114, among other components. The opener disc 114 may also be referred to as an opener wheel. The furrow closer assembly 104 may include one or more closer wheels 116. In some embodiments, the furrow closer assembly 104 may further include a separate fertilizer opener wheel and a fertilizer dispenser. The vertical movement provided by the linkage may allow the trailing arm assemblies 100 to follow or translate up and down as the opener discs 114 and closer wheels 116 negotiate over or through an obstruction in a field surface 80 without adversely impacting seed deposit depth or resulting in damage to the components of the agricultural planter 70.

Because the trailing arm assemblies 100 are able to adjust to the contours of and variances in the field surface 80 through vertical translation via the parallel linkage 110, the opener discs 114 may be in generally consistent contact with the field surface 80, which may improve opening of furrows 106. Similarly, the trailing furrow closer wheels 116 may be in consistent contact with the field surface 80, which improves closing of the seed and fertilizer furrows 106.

The furrow opener assembly 102 may be coupled to the tool bar 75 via a connection that allows the trailing assembly 100 to move relative to the tool bar 75. In any of the examples contemplated herein, the connection may be configured to maintain an approximately constant relative orientation between the furrow opener assembly 102 and the tool bar 75 through the range of motion of the trailing assembly 100. For example, the furrow opener assembly 102 may connect to the tool bar 75 via the parallel linkage 110. In any of the examples disclosed herein, the parallel linkage 110 may include a pair of linkages that are generally arranged along a central longitudinal plane of the row unit.

The furrow closer assembly 104 may be coupled to the furrow opener assembly 102, for example to the opener frame 108, via a connection that allows the furrow closer assembly 104 to move relative to the furrow opener assembly 104. In any of the examples described herein, the connection may be configured to maintain an approximately constant relative orientation between the furrow closer assembly 104 and the furrow opener assembly 102 through the range of motion of the furrow closer assembly 104. For example, the furrow closer assembly 104 may include a closer assembly frame 118, which may be connected to the furrow opener assembly 102, for example to the opener frame 108, via a parallel linkage 120, such as any of the linkage assemblies described herein. In any of the examples contemplated herein, the parallel linkage 120 may include at least a pair of linkages that are generally arranged along a central longitudinal plane of the row unit. In at least one embodiment, the trailing assembly 100 may also include a leading assembly 122 disposed ahead or forward relative to the furrow opener assembly 102.

Any of the features, components, and/or parts, including the arrangements and configurations thereof shown in FIGS. 1-2 may be included, either alone or in any combination, in any of the other examples of devices, features, components, and parts shown in the other figures. Likewise, any of the features, components, and/or parts, including the arrangements and configurations thereof shown in the other figures may be included, either alone or in any combination, in the example of the devices, features, components, and parts shown in FIGS. 1-2.

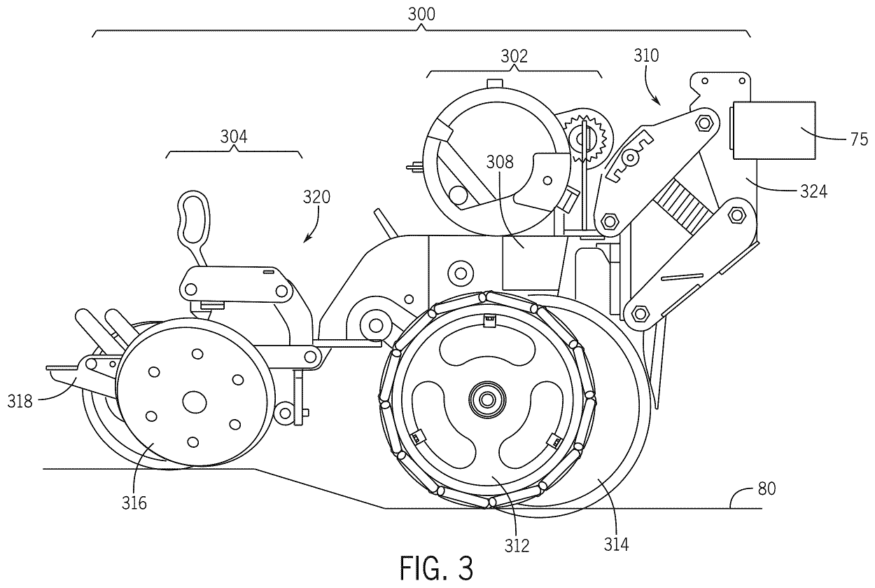

FIG. 3 illustrates a side view of an embodiment of a trailing assembly 300, including a furrow opener assembly 302 and a furrow closer assembly 304. In at least one embodiment, the furrow opener assembly 302 may be secured to a tool bar 75 via a first parallel linkage 310. The parallel linkage 310 may include a set of parallel links rotatably secured to and extending from a first bracket 324 secured to the tool bar 75. In some embodiments, the parallel links of the first parallel linkage 310 are rotatably secured directly to the tool bar 75. The first parallel linkage 310 may also be secured to a opener assembly frame 308 such that the opener assembly frame 308, as well as any opener components of the furrow opener assembly 302 secured thereto, may translate up and down relative to the tool bar 75 as the parallel links rotate. In this way, in at least one embodiment, a gauge wheel 312 and an opener disc 314 interacting or contacting the field surface 80 during use may accommodate rough terrain and maintain a proper depth of the opener disc 314 extending into the field to open a furrow.

In at least one embodiment, the furrow opener assembly 302 is disposed behind or “rearward” from the tool bar 75. In at least one embodiment, the furrow closer assembly 304 may be secured behind the furrow opener assembly 302. For example, a second parallel linkage 320 may secure the furrow closer frame 318 to the furrow opener frame 308. In this way, the furrow closer assembly 304 and components thereof, including the furrow closer frame 318 and one or more furrow closer discs 316, may translate vertically relative to the furrow opener assembly 302 as the trailing assembly 300 is moved forward over the field surface 80.

The gauge wheel 312 is configured to roll across a top surface 80 of the field and set a depth of the opener disc 314 extending into the ground. In at least one embodiment, the gauge wheel 312 is configured to press against but not dig into the surface 80 to maintain the opener frame 308 at a consistent height relative to the surface 80. The opener disc 314 may be rotatably secured to the opener frame 308 such that a depth at which the opener disc 314 penetrates below the surface 80 to form a furrow in the field is also consistent. In this way, in at least one embodiment, the gauge wheel 312 may function to set and maintain the depth of the furrow created by the furrow opener disc 314.

As noted above, the furrow opener assembly 302 may be secured to the tool bar 75 via a parallel linkage 310 such that the furrow opener assembly 302 translates up and down vertically relative to the tool bar 75 as the gauge wheel 312 encounters rough or uneven terrain on the field surface 80. In this way, in at least one embodiment, the furrow opened by the furrow opener disc 314 is a consistent depth regardless of terrain elevation changes.

In addition to compensating for rough terrain, embodiments of the gauge wheel 312 shown in FIG. 3 and described herein may be configured to maintain consistent furrow depths and geometries in a variety of soil conditions. For example, wet or moist soil may tend to stick to and build up on the outer edges and surfaces of the opener disc 314 as the opener disc 314 is moved along and rotates to penetrate the field surface 80. However, embodiments of the gauge wheels 312 described herein may be configured to remove such build up on the opener disc 314 during operation.

Any of the features, components, and/or parts, including the arrangements and configurations thereof shown in FIG. 3 may be included, either alone or in any combination, in any of the other examples of devices, features, components, and parts shown in the other figures. Likewise, any of the features, components, and/or parts, including the arrangements and configurations thereof shown in the other figures may be included, either alone or in any combination, in the example of the devices, features, components, and parts shown in FIG. 3.

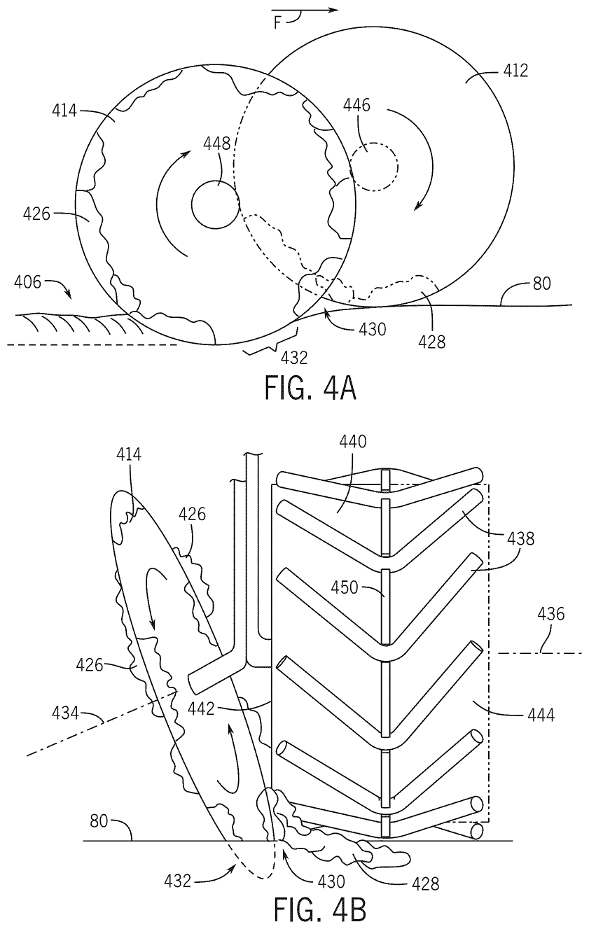

FIG. 4A illustrates a side view of a portion of an embodiment of a trailing assembly, including a gauge wheel 412 and an opener disc 414 as part of a furrow opener assembly. The gauge wheel 412 and opener disc 414 are shown being pulled in the forward direction F such that the gauge wheel 412 and the opener disc 414 are rotating clockwise, as indicated by the arrows according to the orientation of FIG. 4A. The gauge wheel 412 may be configured to rest on or press against the field surface 80 to set a depth of the opener disc 414 extending downward beyond the surface 80 to form a furrow 406 as shown. In at least one embodiment, the furrow opener disc 414 defines a first rotational center 448 and the gauge wheel 412 defines a second rotational center 446. In at least one embodiment, the second rotational center 446 is disposed above the first rotational center 448 relative to the field surface 80 or ground during use. In at least one embodiment, the first rotational center 448 is disposed above the second rotational center 446 but the diameter of the opener wheel or disc 414 is larger than the diameter of the gauge wheel 412 such that a lower-most point or edge of the opener disc 414 is disposed lower than a lower-most point or edge of the gauge wheel 412. In any case, the gauge wheel 412 and the opener disc 414 are positioned and sized relative to one another such that the gauge wheel 412 rests or presses onto the field surface 80 without penetrating or forming a furrow while the opener disc extends below the field surface 80 to form the furrow 406 as shown.

As the assembly is moved in the forward direction F to form the furrow 406, one or more soil conditions or types of soil may cause debris 426, such as the soil itself, to stick to the opener disc 412 after a portion of the opener disc 414 has extended below the field surface 80 and into the soil, as shown. In the embodiment of FIG. 4A, the debris 426 is shown as clumping or accumulating on an outer edge or surface of the opener disc 414 after forming the furrow 406. The debris 426 may stick to the opener disc 414 as the opener disc rotates during use. In some embodiments, the gauge wheel 412 includes a peripheral edge that is positioned adjacent or near the opener disc 412 such that the gauge wheel 412 is configured to scrape debris 426 of the furrow opener wheel or disc 414 as the assembly is pulled in the forward direction F as shown and the gauge wheel 412 and opener disc 414 rotate. In at least one example, the gauge wheel 412 scrapes debris 426 off the opener disc 414 at or near an interference region 430 where the peripheral edge of the gauge wheel 412 is closest to the opener disc 414.

In at least one embodiment, the debris 426 on the opener disc 414 is scraped off or transferred to the gauge wheel 412 and discarded onto the field surface 80. FIG. 4A illustrates some discarded debris 428 removed from the opener disc 414 by the gauge wheel 412. In at least one embodiment, the gauge wheel 412 effectively cleans the debris 426 off the opener disc 414 such that a clean portion 432 of a peripheral edge or surface of the opener disc 414 is prepared to again enter below the field surface 80 to form the furrow 406 as the opener disc 414 rotates during use. This clean portion 432 of the opener disc 414 extends downward into the soil beyond the field surface 80 to form the furrow 406 free of any debris 426 built up at the clean portion 432, thus forming a consistent furrow depth and geometry.

FIG. 4B illustrates a front view of an embodiment of a gauge wheel 412 disposed next to or adjacent a furrow opener disc 414. The gauge wheel 412 may include a rim 450 with a plurality of treads 438 spaced apart from one another around an outer circumferential edge or portion of the rim 450. In addition, in at least one embodiment, the gauge wheel 412 may include a circumferential liner 440 disposed radially inward from the treads 438. The treads 438 and the liner 440 may define an outer peripheral edge of the gauge wheel 412 configured to make contact with or press against the field surface 80 during use. In at least one embodiment, the liner 440 is a first liner and the gauge wheel 412 includes a second liner 444 disposed radially inward from the treads 438. The rim 450 may be disposed between the first and second liners 440, 444.

In at least one embodiment, the liner 440 may define an outer-most peripheral edge 442 of the gauge wheel 412. The outer edge 442 may face the opener disc 414 when assembled together as shown in FIG. 4B. In particular, in at least one embodiment, the outer edge 442 formed by the liner 440 may be disposed at or adjacent the opener disc 414 near a bottom edge of the opener disc 414. In at least one example, a portion of the outer edge 442 of the liner 440 may contact or be in close proximity to the opener disc 414 at the interference region 430 where debris 426 built up on the opener disc 414 is scraped off by the edge 442 of the liner 440 to remove and discard debris 428 from the opener disc 414. In at least one embodiment, the gauge wheel 412 defines a first axis of rotation 436 about which the rim 450, treads 438, and liner(s) 440 (444) rotate while the furrow opener wheel or disc 414 defines a second axis of rotation 434. In at least one embodiment, the first axis of rotation 436 is non-parallel to the second axis of rotation 434. In at least one embodiment, the gauge wheel 412 is assembled to the furrow opener frame or assembly such that the first axis of rotation 436 is generally parallel to the field surface 80 and the second axis of rotation 434 is not parallel to the field surface 80.

In this way, the gauge wheel 412 and opener disc 414 are angled relative to one another such that the outer edge 442 of the liner 440 or gauge wheel 412 contacts or is in close proximity with the opener disc at the interface region 430 while other portions of the outer edge of the opener disc may be further form the outer edge 442 of the liner 440 as the gauge wheel 412 and opener disc 414 rotate during use. In at least one embodiment, the outer edge 442 of the gauge wheel 412 or liner 440 contacts an outer edge or surface of the opener disc 414 facing the outer edge 442 at or within the interface region 430. In at least one embodiment, the outer edge 442 of the gauge wheel 412 or liner 440 is positioned within about 6-inches of an outer edge or surface of the opener disc 414 facing the outer edge 442 at or within the interface region 430. In at least one embodiment, the outer edge 442 of the gauge wheel 412 or liner 440 is positioned within about 3-inch of an outer edge or surface of the opener disc 414 facing the outer edge 442 at or within the interface region 430. In at least one embodiment, the outer edge 442 of the gauge wheel 412 or liner 440 is positioned within about 1-inch of an outer edge or surface of the opener disc 414 facing the outer edge 442 at or within the interface region 430. These distances between the outer edge 442 of the gauge wheel 412 and the opener disc 414 within the interface region 430 have been found to be sufficient to cause the liner 440 to scrape off debris 426 built up on the opener disc 414 during use. The interaction between the outer edge 442 of the gauge wheel 412 and the opener disc 412 at the interface region 430 may cause discarded debris 428 to be pushed back onto the field surface 80 away from the furrow 406 formed by the opener disc 414. In this way, in at least one embodiment, the clean portion 432 of the opener disc 414 penetrates through the field surface 80 to form the furrow 406 free and clear of any debris 426 still stuck to the opener disc 414, which may otherwise negatively affect the consistency, depth, and geometry of the furrow 406.

Any of the features, components, and/or parts, including the arrangements and configurations thereof shown in FIGS. 4A and 4B may be included, either alone or in any combination, in any of the other examples of devices, features, components, and parts shown in the other figures. Likewise, any of the features, components, and/or parts, including the arrangements and configurations thereof shown in the other figures may be included, either alone or in any combination, in the example of the devices, features, components, and parts shown in FIGS. 4A and 4B.

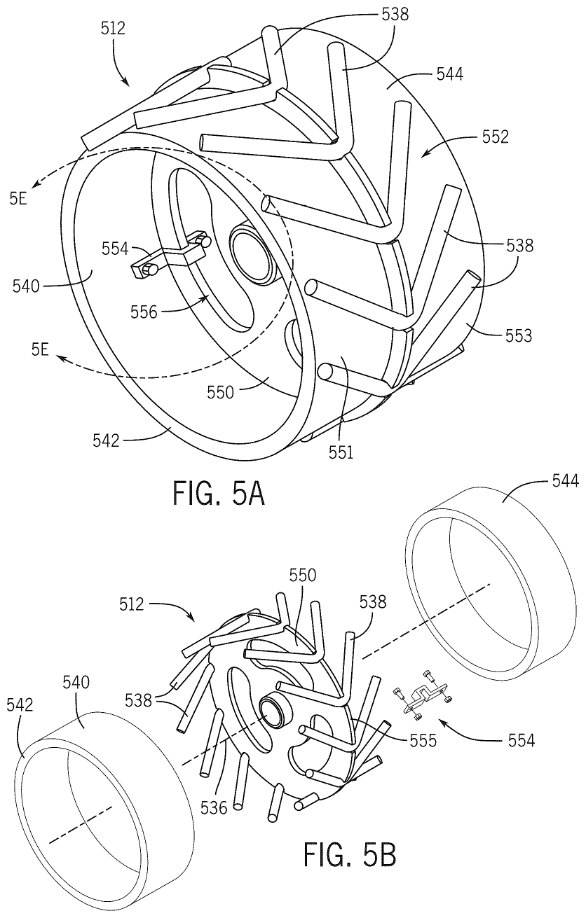

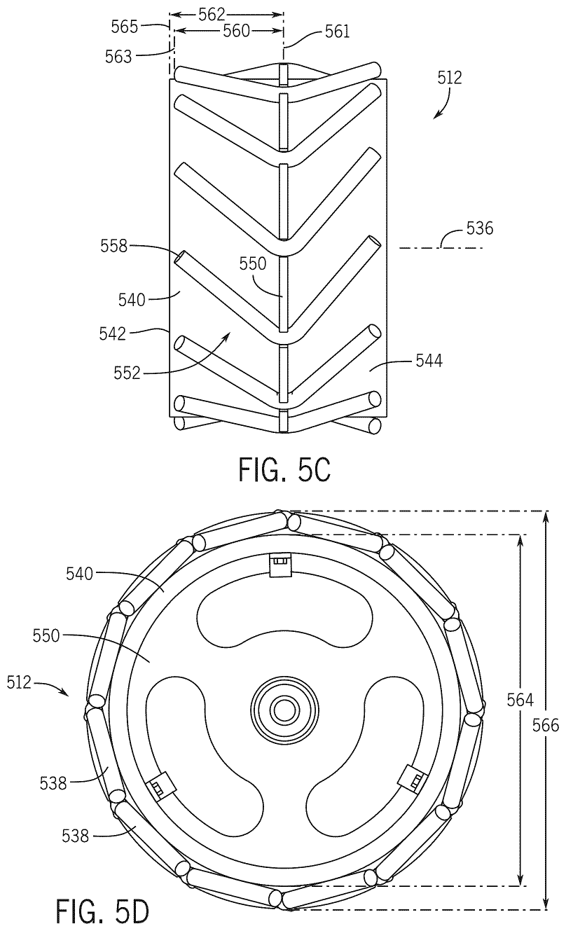

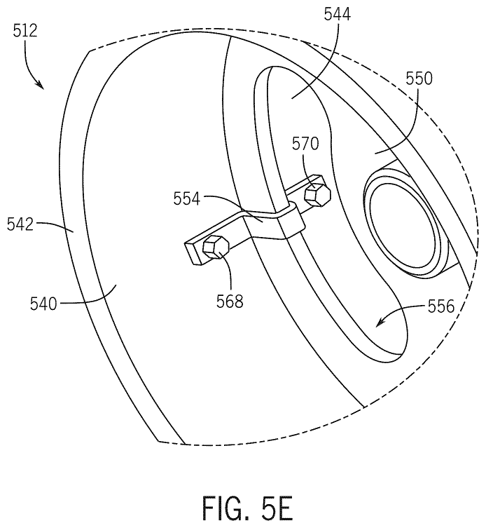

FIGS. 5A and 5B illustrate a perspective and exploded view, respectively of an embodiment of a gauge wheel 512, including a rim 550, treads 538 spaced apart radially about a peripheral edge of the rim 550, a first liner 540 disposed radially inward to the treads 538, and a second liner 544 disposed radially inward to the treads 538 with the rim 550 disposed between the first liner 540 and the second liner 544. In at least one embodiment, the rim 550 includes openings 556 through which a bracket 554 or bracket assembly may pass to secure the liners 540, 544 to together and/or to the rim 550. The first liner defines an outermost edge 542 of the gauge wheel extending laterally from the rim 550 further than an outermost edge of the treads 538. As used herein, the term “outermost” and “laterally” can refer to an extension of the liner 540 away from the rim 550 in a direction normal to the rim 550. Thus, in such examples, the outermost edge of the liner 542 can define an edge within a plane parallel to a major plane defined or occupied by the rim 550, with the liner 540 extending from the rim 550 to the outermost edge 542. In this way, the outermost edge 542 can include a peripheral edge parallel to the rim 550. In at least one embodiment, the first liner 540 defines a first outer circumferential surface 551 and the second liner 544 defines a second outer circumferential surface 553. In at least one embodiment, the treads 538 are disposed on top of the first and second outer circumferential surfaces 551, 553 of the first and second liners 540, 544, respectively. As used herein, the term “circumferential surface” and related terms, indicated at 551 and 553 of FIGS. 5A and 5B, may refer to an outer surface of the gauge wheel 512 configured to press against the surface of a field when rotated or pulled forward during use.

In at least one embodiment, the outer circumferential surfaces 551, 553 of the liners 540, 544 and the treads 538 define an outer circumferential surface 552 of the gauge wheel 512. In at least one embodiment, the treads define a raised portion of the outer circumferential surface 552 of the gauge wheel 512 relative to the first and second outer circumferential surfaces 551, 553 of the liners 540, 544. The each of the plurality of tread portions 538 may be formed from a tine extending from an outer radial surface 555 of the rim 550 in a direction that includes a component in one or more of a radial direction defined by the outer radial surface 555, a component in an axial direction defined by the axis of rotation 536, or a component in a tangential direction thereto. In at least one embodiment, each tine/tread 538 and the radial surface 555 define a tine plane that forms a chord along the radial surface 555 that intersects no more than two chords of adjacent tread portions 538 within the circumferential portion.

In at least one embodiment, the liners 540, 544 forming the outer circumferential surface 552 of the gauge wheel 512 may prevent soil from clogging between the treads 538 and building up on the rim 550. In this way, the liners 540, 544 may act as a barrier to the ingress of soil and dirt between and through the treads 538.

In one or more other embodiments, the treads 538 may include other geometries, shapes, and configurations. The treads 538 shown and described herein are exemplary only. The treads 538 of the gauge wheel 512 may include gaps, spaces, or voids between each adjacent tread 538. As noted above, the treads 538 may define raised portions of the outer circumferential surface 552 of the gauge wheel. These raised portions provide an uneven surface of the gauge wheel 512 configured to press against and contact soil of the field surface 80. The uneven surface including the treads 538 and outer circumferential surfaces 551, 553 of the liners 540, 544 may prevent moist soil from the field sticking and accumulating on the gauge wheel 512 as the gauge wheel 512 rolls along the surface 80 during use. In addition, the uneven structure of the outer circumferential surface 552 of the gauge wheel 512 may disturb the soil while simultaneously pressing the soil underneath the gauge wheel 512 to further prepare the field surface 80 for the formation of the furrow by the opener disc assembled adjacent to the gauge wheel 512.

In at least one embodiment, the first and/or second liner 540, 544 may include a curved, closed loop configuration or shape. In at least one embodiment, the first and/or second liner 540, 544 may include a tube or tubular structure, for example a cylindrical tube, as shown. In at least one embodiment, the first and/or second liner 540, 544 may include a tubular structure. In at least one embodiment, one or more of the first and second liners 540, 544 may be removably attached to the gauge wheel 512 and/or the rim 550 thereof. In at least one embodiment, the first and/or second liners 540, 544 may be integrally formed with the rim 550 and treads 538 of the gauge wheel 512 such that the first and/or second liners 540, 544 are not removable. In such an embodiment, the gauge wheel 512 as shown in FIG. 5A may be integrally formed as a single piece.

FIG. 5C illustrates a front view of the agricultural gauge wheel 512 shown in FIGS. 5A and 5B. In the illustrated embodiment, the gauge wheel 512 may include a hub as part of the rim 550 configured to rotate about the axis 536. The rim 550 may extend radially from the axis 536 and define a circumferential portion and a center plane 561. The center plane 561 may be defined as a plane perpendicular to the axis 536 and bisecting the rim 550. In at least one embodiment, the treads 538 may extend away from the center plane 561 to an outer tread edge 558. The plurality of treads 538 defining the outer tread edge 558 may define a tread edge plane 563 parallel to the center plane 561. In addition, in at least one embodiment, the outermost peripheral edge 542 defined by the liner 540 may define an outer liner edge plane 565 parallel to the tread edge plane 563 and the center plane 561. As shown, in at least one embodiment of the gauge wheel 512, the outer liner edge 542 may be disposed beyond the outer tread edge 558 relative to the rim 550 or the center plane 561. In other words, in at least one embodiment, a first distance 560 between the center plane 561 and the tread edge plane 563 may be less than or equal to a second distance 562 between the center plane 561 and the liner edge plane 565 such that the outermost peripheral edge 542 of the liner 540 defines the outermost peripheral edge of the gauge wheel 512 configured to scrape debris of an adjacent opener disc as part of a furrow opener assembly.

FIG. 5D illustrates a side view of the embodiment of the gauge wheel 512 shown in FIGS. 5A-5C. In at least one embodiment, the liner 540 is secured to the rim 550 radially inward form the treads 538. For example, as shown in FIG. 5D, the distance 564 indicates an inner diameter of the treads 538 and an outer diameter of the liner 540. In the illustrated embodiment, the outer diameter of the liner 540 is equal to the inner diameter of the treads 538 and an outer diameter 566 of the treads 538 is greater than an outer diameter of the liner 540. In at least one embodiment, the outer diameter of the liner 540 may be less than the inner diameter of the treads 538.

FIG. 5E illustrates a close up perspective view of a portion of the gauge wheel 512 as indicated in FIG. 5A, including the first liner 540 defining the outer edge 542. The close up view of FIG. 5E shows the cylindrical liner 540 secured to the rim 550 via a bracket 554 mechanically secured to the liner 540 via a first fastener 568. In at least one embodiment, the bracket 554 extends from the first liner 540, through the hole 556 in the rim 550, and onto the second liner 544. The bracket 554 may be secured to the second liner 544 via a second fastener 570. In this way, the first and second liners 540, 544 are secured together and across the rim 500 to secure both liners 540, 544 to the rim 550. In at least one embodiment, the first liner 540 is removably secured to the rim 550. In at least one embodiment, the second liner 544 is removably secured to the rim 550.

In at least one embodiment, the bracket 554 is one of a plurality of brackets or other fasteners securing the liners 540, 544 to each other and/or to the rim 550. In at least one embodiment, the liners 540, 544 may be welded to the rim 550. In at least one embodiment, the liners 540, 544 may be adhered to the rim 550 via epoxy or one or more other forms of glue. In at least one embodiment, each of the first and second liners 540, 544 may be secured directly to the rim 550 via the bracket 554 without being secured to the other liner 540, 544 on the other side of the rim 550.

In at least one embodiment, one or both of the liners 540, 544 may be narrower than the treads 538 such that an outer edge of the treads define an outermost peripheral edge of the gauge wheel 512 rather than the liner 540, 544 defining the outermost peripheral edge of the gauge wheel 512.

Any of the features, components, and/or parts, including the arrangements and configurations thereof shown in FIGS. 5A-5E may be included, either alone or in any combination, in any of the other examples of devices, features, components, and parts shown in the other figures. Likewise, any of the features, components, and/or parts, including the arrangements and configurations thereof shown in the other figures may be included, either alone or in any combination, in the example of the devices, features, components, and parts shown in FIGS. 5A-5E.

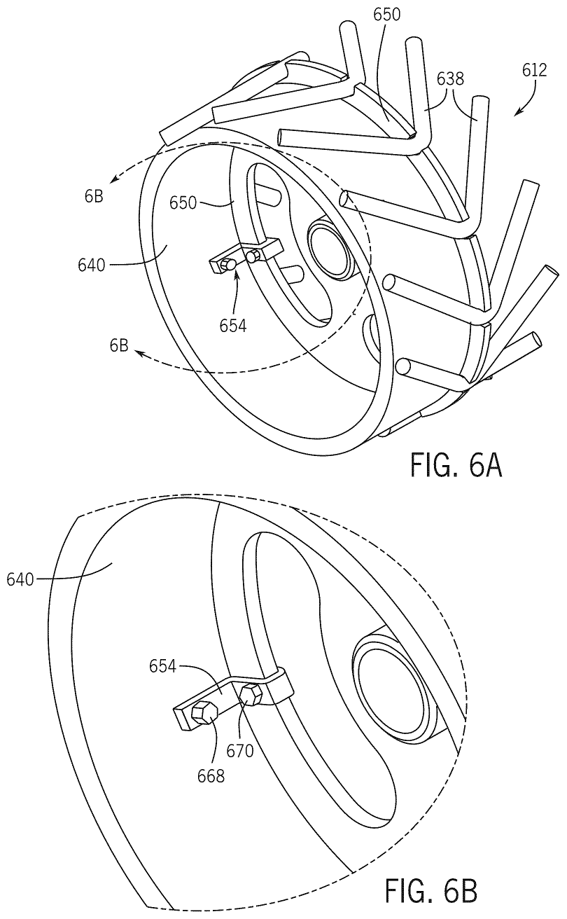

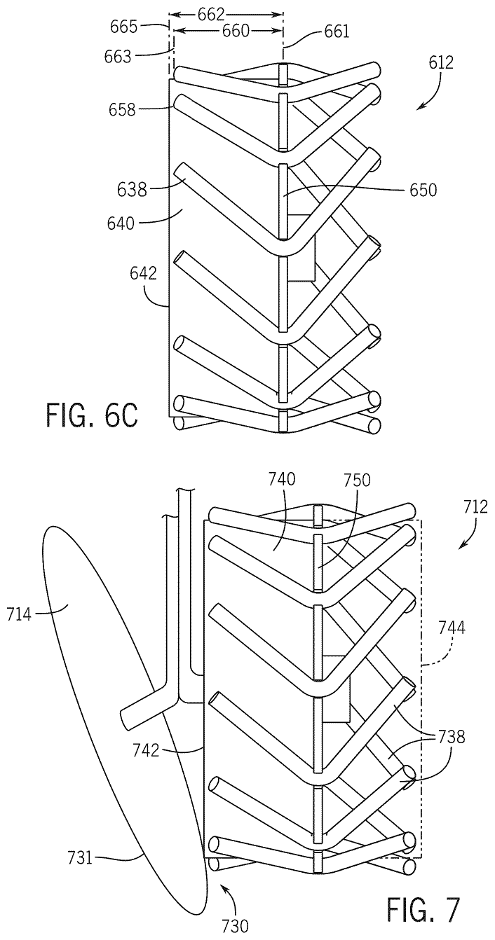

FIGS. 6A-6C illustrate various views of another embodiment of a gauge wheel 612. For example, FIG. 6A illustrates a perspective view of the gauge wheel 612, which includes a rim 650 having a plurality of treads 638 spaced apart circumferentially around the rim 650 and a liner 640 disposed radially inward to the treads 638. In the illustrated embodiment, the gauge wheel 612 includes only a single liner 640 disposed radially inward from the treads 638 on one side of the rim 650. FIG. 6B illustrates a close up view of the portion of the gauge wheel 612 as indicated in FIG. 6A. As shown, the bracket 654 may be secured to the liner 640 via a first fastener 668 and to the rim 650 via a second fastener 670. In at least one embodiment, the liner 640 may be secured to the rim 650 via one or more other means, including adhesive, welding, or other mechanism fastening mechanisms and devices. In any case, the liner 640 may be secured to the rim 650 such that the liner 640 rotates along with the gauge wheel 612, including the rim 650 and the treads 638, during use.

FIG. 6C illustrates a front view of the gauge wheel 612 shown in FIGS. 6A and 6B. The gauge wheel 612 may include a center plane 661 define by the rim 650. The center plane 661 may be defined as a plane bisecting the rim 650. In at least one embodiment, the treads 638 may extend away from the center plane 661 to an outer tread edge 658. The plurality of treads 638 defining the outer tread edge 658 may define a tread edge plane 663 parallel to the center plane 661. In addition, in at least one embodiment, the outermost peripheral edge 642 defined by the liner 640 may define an outer liner edge plane 665 parallel to the tread edge plane 663 and the center plane 661. As shown, in at least one embodiment of the gauge wheel 612, the outer liner edge 642 may be disposed beyond the outer tread edge 658 relative to the rim 650 or the center plane 661. In other words, in at least one embodiment, a first distance 660 between the center plane 661 and the tread edge plane 663 may be less than or equal to a second distance 662 between the center plane 661 and the liner edge plane 665 such that the outermost peripheral edge 642 of the liner 640 defines the outermost peripheral edge of the gauge wheel 612 configured to scrape debris of an adjacent opener disc as part of a furrow opener assembly.

Any of the features, components, and/or parts, including the arrangements and configurations thereof shown in FIGS. 6A-6C may be included, either alone or in any combination, in any of the other examples of devices, features, components, and parts shown in the other figures. Likewise, any of the features, components, and/or parts, including the arrangements and configurations thereof shown in the other figures may be included, either alone or in any combination, in the example of the devices, features, components, and parts shown in FIGS. 6A-6C.

FIG. 7 illustrates a front view of a portion of a furrow opener assembly including a furrow opener wheel or disc 714 and an embodiment of a gauge wheel 712 for setting a depth of the opener disc 714 configured to extend into a field to form a furrow. As shown, the gauge wheel 712 may include a rim 750 and a plurality of treads 738 spaced apart and extending form the rim 705. In addition, the gauge wheel 712 may include a liner 740 disposed radially inward from the treads 738 and next to the rim 750. A second liner 744 is shown in dotted lines disposed on the opposite side of the rim 750. The second liner 744 is illustrated in dotted lines to indicate the second liner 744 may be optional or removably attached to the gauge wheel 712 as needed or desired by the user. The first liner 740 may also be removably attached to the gauge wheel 712 as needed or desired.

In at least one embodiment, the liner 740 defines an outermost peripheral edge 742 of the gauge wheel 712 extending laterally beyond an outer edge of the tread portions 738. In at least one embodiment, the outer, lateral edge defined by the treads 738 extends to the same distance laterally relative to the rim 750 as the outermost edge 742 of the liner 740. In any case, the outermost edge 742 of the liner 740 defines an outermost edge of the gauge wheel 712.

In at least one embodiment, as illustrated in FIG. 7, the outermost edge 742 contacts or is disposed within close proximity to an outer peripheral edge 731 of the opener wheel or disc 714 at or near the interface region 730. The interface region 730 may be defined as a region or area in which the outermost edge 742 of the gauge wheel 712 is close enough to the outer peripheral edge 731 or surface of the opener disc 714 to effectively interfere with any debris that may be accumulated on the opener disc 714. In this way, the liner 740 may be configured to scrape any debris off the opener disc 714 as the opener disc 714 rotates and extends into the soil during rotation of the opener disc 714 and gauge wheel 712.

Any of the features, components, and/or parts, including the arrangements and configurations thereof shown in FIG. 7 may be included, either alone or in any combination, in any of the other examples of devices, features, components, and parts shown in the other figures. Likewise, any of the features, components, and/or parts, including the arrangements and configurations thereof shown in the other figures may be included, either alone or in any combination, in the example of the devices, features, components, and parts shown in FIG. 7.

Although various representative embodiments of this invention have been described above with a certain degree of particularity, those skilled in the art could make numerous alterations to the disclosed embodiments without departing from the spirit or scope of the inventive subject matter set forth in the specification and claims. The various embodiments discussed herein are not exclusive to their own individual disclosures. Each of the various embodiments may be combined with or excluded from other embodiments. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

Other examples and implementations are within the scope and spirit of the disclosure and appended claims. For example, features implementing functions may also be physically located at various positions, including being distributed such that portions of functions are implemented at different physical locations. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. An agricultural gauge wheel, comprising:
a hub which rotates about an axis;
a rim extending generally radially from the axis, the rim defining a circumferential portion and a center plane defined as a plane perpendicular to the axis and bisecting the rim;
a tread including a plurality of tread portions extending away from the center plane to an outer tread edge, wherein the plurality of tread portions define an inside diameter of the tread; and
a liner secured to the rim, the liner including an outer diameter less than or equal to the inside diameter of the tread, the liner defining an outer edge of the agricultural gauge wheel.

2. The agricultural gauge wheel of claim 1, the tread defining voids between adjacent tread portions.

3. The agricultural gauge wheel of claim 1, the liner defining an outer liner edge disposed further beyond the outer tread edge relative to the center plane.

4. The agricultural gauge wheel of claim 1, wherein the liner includes a closed loop configuration.

5. The agricultural gauge wheel of claim 1, wherein the liner is a first liner and the agricultural gauge wheel further includes a second liner.

6. The agricultural gauge wheel of claim 5, wherein the rim is disposed between the first liner and the second liner.

7. The agricultural gauge wheel of claim 1, wherein each of the tread portions are formed from a tine extending from a radial surface of the rim in a direction that includes a component in one or more of a radial direction, a component in an axial direction, or a component in a tangential direction.

8. The agricultural gauge wheel of claim 7, wherein the tine and the radial surface define a tine plane that forms a chord along the radial surface that intersects no more than two chords of adjacent tread portions within the circumferential portion.

9. An agricultural gauge wheel, comprising:
a rim;
a plurality of spaced apart tread portions extending from the rim and defining raised portions of an outer surface of the wheel configured to press against a field surface; and
a cylindrical liner disposed radially inward from the plurality of spaced apart tread portions, the cylindrical liner defining the outer surface of the wheel.

10. The wheel of claim 9, wherein the cylindrical liner defines an outermost peripheral edge of the wheel and the outermost peripheral edge disposed in a plane parallel to the rim.

11. The wheel of claim 9, wherein the cylindrical liner is tubular and secured to the rim.

12. The wheel of claim 9, wherein:
the cylindrical liner is a first cylindrical liner disposed on a first side of the rim; and
the wheel further includes a second cylindrical liner disposed on a second side of the rim opposite the first side such that the rim is disposed between the first cylindrical liner and the second cylindrical liner.

13. The wheel of claim 12, wherein the first cylindrical liner is secured to the second cylindrical liner via a bracket extending through the rim.

14. The wheel of claim 9, wherein the cylindrical liner is removably attached to the wheel.

15. A trailing assembly, comprising:
a furrow opener wheel; and
a gauge wheel including a peripheral edge adjacent the furrow opener wheel,
wherein the peripheral edge is configured to scrape debris off of the furrow opener wheel during use.

16. The trailing assembly of claim 15, wherein:
the gauge wheel includes a rim rotatable around a first axis of rotation, the rim defining a first plane;
the peripheral edge defines a second plane parallel to the first plane; and
the second plane is disposed between the furrow opener wheel and the first plane.

17. The trailing assembly of claim 16, further comprising a plurality of tread portions extending away from the first plane to an outer tread edge.

18. The trailing assembly of claim 17, wherein:
a first distance separates the peripheral edge from the first plane;
a second distance separates the outer tread edge from the first plane; and
the second distance is less than or equal to the first distance.

19. The trailing assembly of claim 16, wherein the furrow opener wheel defines a second axis of rotation non-parallel to the first axis.

20. The trailing assembly of claim 15, wherein:
the furrow opener wheel defines a first rotational center;
the gauge wheel defines a second rotational center; and
the second rotational center is disposed above the first rotational center relative to a field surface during use.
